(19) United States
(12) Patent Application Publication
(10) Pub. No.: US 2007/0206758 A1
(43) Pub. Date: Sep. 6, 2007

(54) System and method for communicating with a plurality of participants

(76) Inventor: Zvi Barak, Raanana (IL)

Correspondence Address: HENRY M. SINAI;(IP-PARTNERSHIP), P.O. BOX 669, RAANANA, 43350, IL

(21) Appl. No.: 10/579,053

(22) PCT Filed: Nov. 30, 2004
(86) PCT No.: PCT/IL04/01093

§ 371 Date: May 11, 2006

Related U.S. Application Data
(60) Provisional application No. 60/525,844, filed on Dec. 1, 2003.

(51) Int. Cl. H04M 3/42

(52) U.S. Cl. 379/202.01

(57) ABSTRACT

A system and method for a party to independently and directly communicate with a group of people for the purposes of transmitting and/or receiving voice and data information is provided. The directing party is in control of the entire dialing and broadcasting process in real time, including initiating the communication, preparing the script and analyzing the results.

### FIELD OF THE INVENTION

The present invention relates generally to a method and system for simultaneously communicating with a plurality of participants.

### BACKGROUND OF THE INVENTION

Automatic dialers that enable businesses to broadcast phone messages without the use of call center agents are known. The messages being broadcast are prepared by the service bureau managing the automatic dialers. The user (client) who wishes to communicate with a group of people is required to undertake a lengthy and possibly expensive process which is more suitably geared to mass dialing.

Generally, the client contacts the customer service representative (of the service bureau) who builds the script for the client, gets the telephone list from the client (or provides a general list for the client) and prepares the recording. Then, the representative tests the script, obtains the client approval and finally schedules the task to be run. Building a script normally requires trained staffs that are familiar with a particular script building application.

However, the client does not have direct access to the application and the dialer. Thus, the client is entirely dependent on the service bureau and cannot launch the service on his own.

### SUMMARY OF THE INVENTION

The present application enables any user to independently and directly communicate with any group of people. For example, the user can automatically dial a pre-determined list of phone numbers, deliver a message and receive responses from his customers utilizing a script which the user himself can build.

There is thus provided, in accordance with an embodiment of the present invention, a system for a directing party to control the simultaneously communication with a plurality of participants. The system includes a control unit directly controlled by the directing party, a first server in remote communication with the control unit, a second dialing server in communication with the first server. The second dialing server is configured to simultaneously communicate with the plurality of participants in real-time.

Furthermore, in accordance with an embodiment of the present invention, the control unit communicates with the first server via the Internet. The first server and the second dialing server may be combined in a single unit.

Furthermore, in accordance with an embodiment of the present invention, the second dialing server may communicate with the plurality of participants via a Public Switched Telephone Network (PSTN) to any of a group of communication devices associated with the participants including land line telephones, personal computers, cellular telephones, facsimile machines, and cable TV.

Furthermore, in accordance with an embodiment of the present invention, the dialing server may be configured to communicate with any combination of participants and communication devices via any of a group of communication protocols including interactive television, cable or satellite.

Furthermore, in accordance with an embodiment of the present invention, the first server may include a scheduler for allocating time slots available for communication via the second dialing server.

In addition, there is also provided, in accordance with an embodiment of the present invention, a method for communicating with a plurality of participants. The method includes the step of a directing party independently controlling the simultaneous communication with the plurality of participants in real-time.

Furthermore, in accordance with an embodiment of the present invention, the step of independently controlling may include the steps of:

initiating the simultaneous communication; and

analyzing the responses of the plurality of participants to the simultaneous communication.

Furthermore, in accordance with an embodiment of the present invention, the step of independently controlling may include the step of:

terminating the simultaneous communication after an analysis of the responses from a percentage of the plurality of participants.

Furthermore, in accordance with an embodiment of the present invention, the simultaneous communication may include any of a group of services including polling, consumer surveys, sending messages, sending alerts and conducting interviews.

Furthermore, in accordance with an embodiment of the present invention, the step of initiating may include the steps of:

preparing a distribution list associated with the plurality of participants;

filtering the distribution list in accordance with the type of communication being conducted;

constructing a script associated with the type of communication being conducted; and

distributing the script to the filtered distribution list.

Additionally, in accordance with an embodiment of the invention, the distribution list may include any of a group of lists including telephone numbers, email addresses, account numbers and cable IDs.

Furthermore, in accordance with an embodiment of the present invention, the step of constructing a script may include the step of defining and recording any of a group of elements including messages, questions and possible alternative answers to the questions.

Furthermore, in accordance with an embodiment of the present invention, the step of constructing a script may include the step of permitting the plurality of participants to transfer to a human resource for specific interactive discussions.

Furthermore, in accordance with an embodiment of the present invention, the step of defining and recording may include the step of allowing the plurality of participants to submit their responses to the questions in any of a group of communication methods including DTMF, SMS, voice and via interactive television.

Additionally, in accordance with an embodiment of the present invention, the step of initiating may include the steps of:

defining the time period to be associated with the communication; and

defining the recurrence interval of the communication.

Furthermore, in accordance with an embodiment of the present invention, the step of determining may include the steps of:

determining the telephony resources available;

calculating the length of each call; and

determining the number of telephones required for the service, based on the length of each call and the size of the distribution list.

Furthermore, in accordance with an embodiment of the present invention, the step of determining may include the step of the directing party allocating a level of priority to the communication.

Furthermore, in accordance with an embodiment of the present invention, the step of determining may also include the steps of:

the system denying the service due to shortage of resources available at the time period requested; and

the directing party rescheduling the time period for the communication in accordance with the telephony resources available and level of priority.

Furthermore, in accordance with an embodiment of the present invention, the step of determining may include the step of:

comparing the cost of the communication with the credit available to the client.

Furthermore, in accordance with an embodiment of the present invention, the step of determining may include the step of requesting additional credit to cover the cost of the communication or denying the service if not enough credit is available.

Additionally, in accordance with an embodiment of the present invention, the step of analyzing the responses may include the steps of:

analyzing the participants input;

preparing a report; and

transmitting the report in real time to the directing party.

Furthermore, in accordance with an embodiment of the present invention, the report may comprise any of a group of reporting formats including lists, graphs and charts

Furthermore, in accordance with an embodiment of the present invention, the step of initiating may include the steps of:

allocating a time slot for a plurality of callers to dial a dedicated number;

preparing and recording a script; and

playing the script to the plurality of callers.

Finally, the step of initiating may include the step of permitting the plurality of callers to transfer to a human resource for specific interactive discussions.

### BRIEF DESCRIPTION OF THE DRAWINGS

The present invention will be understood and appreciated more fully understood from the following detailed description taken in conjunction with the appended drawings in which:

FIG. 1 is a schematic block diagram illustration of a system for simultaneously communicating with a plurality of participants, constructed and operative in accordance with a further embodiment of the present invention; and

FIG. 2 is a flow chart illustration of the operation of the system of FIG. 1.

### DESCRIPTION OF THE PRESENT INVENTION

The present invention allows a directing party (user) to independently and directly communicate with a group of people for the purposes of transmitting and/or receiving voice and data information, for example. The present invention allows the directing party to control the entire dialing and broadcasting process in real time, including initiating the communication, preparing the script and analyzing the results.

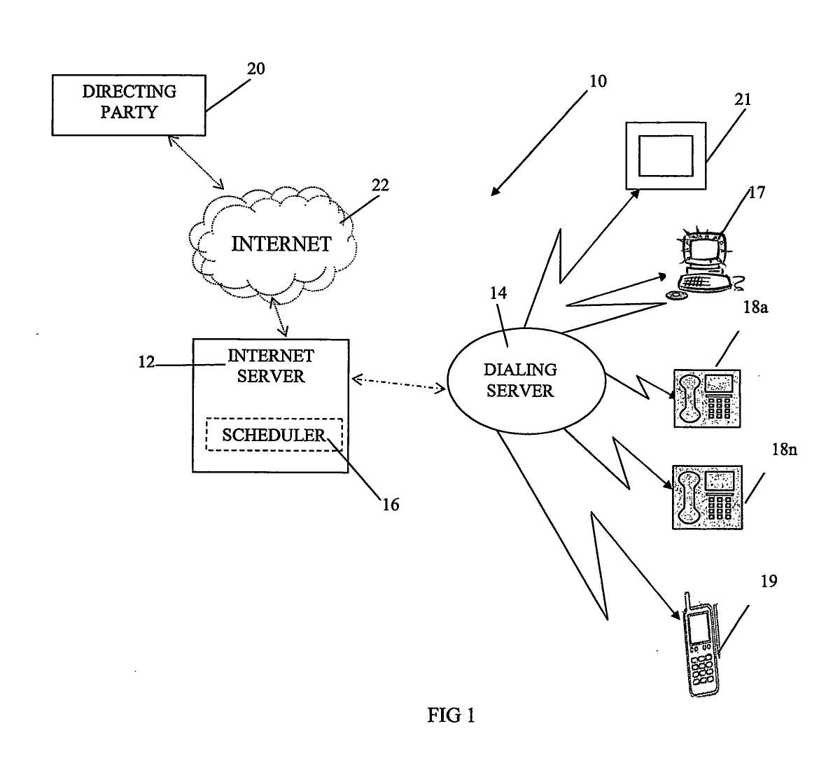

Reference is now made to FIG. 1, which is a schematic block diagram illustration of a system for communicating with a plurality of participants, generally designated 10, constructed and operative in accordance with a preferred embodiment of the present invention.

In an embodiment of the invention, the system 10 comprises a dedicated Internet server 12, which is in communication with a communications server such as a dedicated dialing server 14. The Internet server 12 may comprise a scheduler 16 which keeps a record of time slots available for client communications. It will be appreciated by persons knowledgeable in the art that server 12 may be any suitable server including an Intranet server or any interactive server including interactive television, enabling communication between computers.

In an alternative embodiment of the invention, servers 12 and 14 may be combined in a single unit.

Dialing server 14 is configured to communicate with a plurality of participants in real-time and simultaneously via a telephone network, such as a Public Switched Telephone Network (PSTN) (18) to the participants' telephones 18a . . . 18n, their computers 17, cellular phones 19 or facsimile machines, for example. Alternatively, the dialing server may utilize cable TV to dial to a plurality of interactive TV subscribers 21. Furthermore, the dialing server may be configured to communicate with any combination and any number of communication devices via any communication network.

For example, if there is a bank of 100 phone lines connected to the dialing server 14, 100 calls may be made simultaneously and thus if it is required to poll 1000 participants, and each call is set at 2 minutes, the group of 1000 may be automatically polled in 20 minutes.

The party 20 wishing to receive or transmit a message to a plurality of people may communicate over the Internet 22, for example, with the Internet server 12 with instructions for polling and communicating with the desired participants.

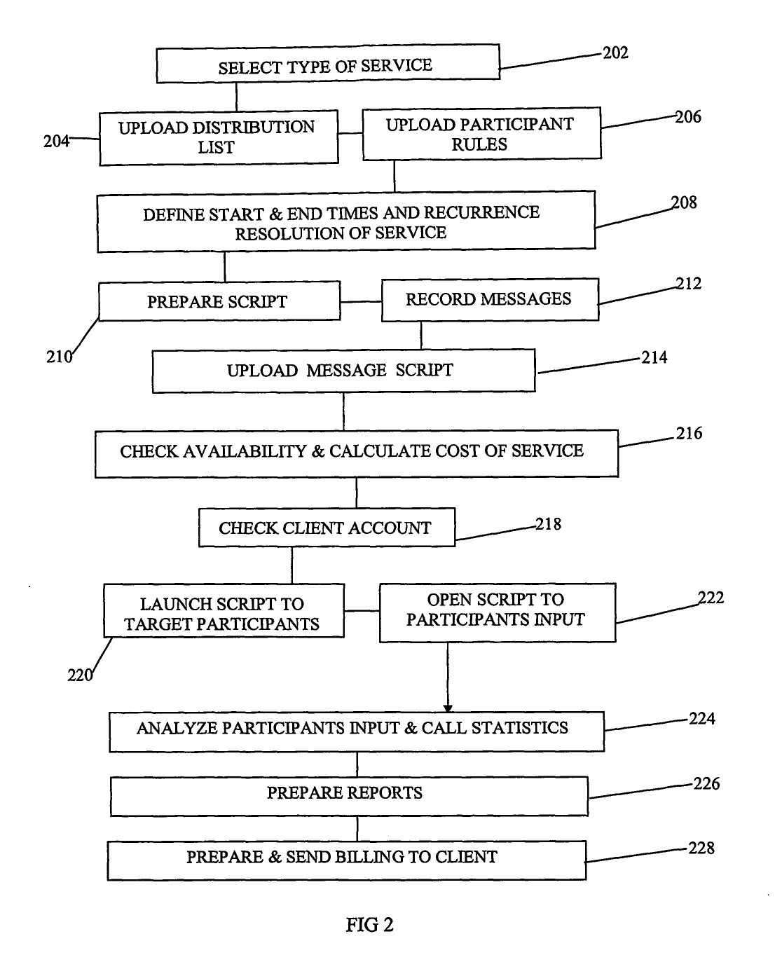

Reference is now made to the flow chart of FIG. 2, which is an illustrative example of a method of directly controlling the distribution of a script to a group of participants.

In the first stage, the directing party 20 selects the type of service (step 202) required. Any type of communicating or broadcasting service may be selected such as conducting polls and consumer surveys, sending messages or alerts and conducting interviews, for example.

Then, the directing party 20 uploads the distribution list for the communication (step 204). The distribution list may comprise phone numbers, email addresses, account numbers, cable IDs, for example. The “participation rules”, that is, the criteria which is relevant to the communication, may then be uploaded (step 206). The “participation rules” may consist of conditions or filters, such as a pattern or group of phone numbers and email address domains for example. The start and end times required for distribution of the service, as well as the recurrence interval, may be defined (step 208). The directing party 20 creates and modifies the script suited to the type of service required (step 210). The script may be constructed from a series of logical building blocks and templates via the Internet. An exemplary script may comprise, for example, a message together with a number of questions and a selection of possible alternative answers for each question for the participants to choose from. The building blocks may comprise a plurality of different components such as a recorded message, a text message, an email message, and a set of recorded questions and answers, for example. The script may allow answers to be given in various ways, such as DTMF, SMS, voice or via interactive television.

Optionally, the script may permit the participants to transfer to a human resource for specific interactive discussions.

The script to be distributed for the service is defined and recorded (step 212) using templates or self recorded messages, for example. Alternatively, the script may be created offline using appropriate software and afterwards uploaded (step 214).

In the next stage of the operation, after all the relevant data for the requested service has been uploaded and received, the Internet server 12 determines the availability and cost of the service (step 216).

The availability and cost of the service may be dependent on telephony or other resources and priorities. A higher priority service may incur extra charges, for example. The length of each call based on the script and the approximate total length and cost of the service based on the length of each call and number of calls is calculated, if relevant. The scheduler 16 checks availability for the total length of time required for the service. If a slot is not available for the total length of time required, the service may be denied and/or an alternative slot may be proposed. Once the time criteria are met, the time slot for the requested service may be reserved.

Once the total cost of the service is known, the status of the client's (that is, the directing party) account, such as the balance and credit available, may be checked (step 218). If there is insufficient credit available, the directing party 20 is alerted and the service may be denied until sufficient credit is available.

Once the requested service has been accepted, the script may be launched to the target audience (via the communications server 14) at the desired time (step 220). The script (where applicable) is opened for the participants input (step 222) at the allotted time.

In the third and final stage of the operation, the Internet server 12 analyzes the participants' input (step 224) and prepares a report for the directing party 20 (step 226). The report may be in any format and may comprise the results of the communication including statistics (such as lists and graphs for example) of the distribution and response of the participants. The results may be printed as a report and/or distributed and shared on the web, for example. Finally, the Internet server 12 may prepare the invoice for billing the client (step 228).

At the end of the operation, the client's (directing party) account may be updated automatically and advised to the client.

A report (in any format) may be distributed directly to the directing party 20 in real time, as results are received. For example, in a polling survey distributed to say 5000 participants over 250 lines, an analysis of the participants' responses may be constantly updated in real time as the results come in. Thus, after each batch of 250 responses is received, an analysis of the results to date (partial analysis) may be made and output to the directing party.

Since the directing party is in control of the survey, he may decide to stop the polling before all the listed participants have been polled. For instance, if the analysis after four or five batches of 250 participants remains constant, he may decide that the results from 1000 participants are acceptable and that he does not need to complete the polling of the remaining 4000 participants and could then terminate the process.

Thus, the directing party has full control from start to finish of the communication service. He may, at his option, re-launch the script for all or part of the distribution list. For example, he may re-launch the script only for those participants who were busy, did not answer or did not provide any input, for example.

It will be appreciated by persons knowledgeable in the art that the system and method described hereinabove is suitable for numerous applications, as illustrated in the examples below:

### EXAMPLE 1

### Emergency Notices

An emergency notice may be prepared quickly by the directing party and distributed within a very short time (minutes). For example, an airline may wish to notify passengers of a delayed or cancelled flight, or, organizers of a convention of 200 people may have to cancel at a few hours notice. In both cases, a script may be quickly prepared and simultaneously distributed to all the persons involved. The cost is relatively small and may be efficiently used for small groups. In contrast, prior art systems require the dialing service to prepare the script and distribute; a system which is much more complex, time consuming and not suitable for emergency situations.

### EXAMPLE 2

### Small Group Notifications

Since the present invention is cost efficient, it is ideally suitable for small groups such as PTAs and churches, for example. The system of the present invention may be used to notify members and congregants of group events or conduct surveys, for example. By using the service, at 10 cents per minute, a call to 200 members will cost $20 and can be run within minutes, once the list of members is loaded. The traditional service bureau cannot offer this type of service, since the labor cost in preparing and distributing a script is much higher.

In an alternative embodiment of the invention, the service may be used for receiving incoming calls from a group of callers. For example, a set time may be allocated for callers to dial a dedicated number to take part in a survey, vote or respond to an advertised job. In the latter case, the directing party may prepare a standard series of questions and answers relevant to the job and effectively interview potential applicants.

Optionally, callers may transfer to a live agent during the call for more specific discussions.

It will be further appreciated that the present invention is not limited by what has been described hereinabove and that numerous modifications, all of which fall within the scope of the present invention, exist. For example, the present invention may be applicable to any type of communications service and protocol, such as interactive television via cable or satellite. The service may be used with cellular and other telephone networks. Rather the scope of the invention is defined by the claims, which follow:

1. A system for a directing party to simultaneously communicate with a plurality of participants comprising:
a control unit directly controlled by the directing party;
a first server in remote communication with said control unit;
a second dialing server in communication with said first server, the second dialing server being configured to simultaneously communicate with the plurality of participants in real-time;
wherein said directing party controls the communication with the plurality of participants.

2. The system according to claim 1, wherein said control unit communicates with said first server via the Internet.

3. The system according to claim 1, wherein said first server and said second dialing server are combined in a single unit.

4. The system according to claim 1, wherein said second dialing server communicates with the plurality of participants via a Public Switched Telephone Network (PSTN) to any of a group of communication devices associated with the participants including land line telephones, personal computers, cellular telephones, facsimile machines, and cable TV.

5. The system according to claim 1, wherein said dialing server is configured to communicate with any combination of participants and communication devices via any of a group of communication protocols including interactive television, cable or satellite.

6. The system according to claim 1, wherein said first server comprises a scheduler for allocating time slots available for communication via said second dialing server.

7. A method for communicating with a plurality of participants, said method comprising the step of:
a directing party independently controlling the simultaneous communication with the plurality of participants in real-time.

8. The method according to claim 7, wherein said step of independently controlling comprises the steps of:
initiating the simultaneous communication; and
analyzing the responses of the plurality of participants to said simultaneous communication.

9. The method according to claim 8, wherein said step of independently controlling comprises the step of:
terminating the simultaneous communication after an analysis of the responses from a percentage of the plurality of participants.

10. The method according to claim 7, wherein said simultaneous communication comprises any of a group of services including polling, consumer surveys, sending messages, sending alerts and conducting interviews.

11. The method according to claim 8, wherein said step of initiating comprises the steps of:
preparing a distribution list associated with said plurality of participants;
filtering said distribution list in accordance with the type of communication being conducted;
constructing a script associated with the type of communication being conducted; and
distributing the script to the filtered distribution list.

12. The method according to claim 11, wherein said distribution list comprises any of a group of lists including telephone numbers, email addresses, account numbers and cable IDs.

13. The method according to claim 11, wherein said step of constructing a script comprises the step of defining and recording any of a group of elements including messages, questions and possible alternative answers to said questions.

14. The method according to claim 11, wherein said step of constructing a script comprises the step of permitting the plurality of participants to transfer to a human resource for specific interactive discussions.

15. The method according to claim 13, wherein said step of defining and recording comprises the step of allowing the plurality of participants to submit their responses to said questions in any of a group of communication methods including DTMF, SMS, voice and via interactive television.

16. The method according to claim 8, wherein said step of initiating comprises the steps of:
defining the time period to be associated with the communication; and
defining the recurrence interval of the communication.

17. The method according to claim 7, further comprising the step of determining the availability and cost of the service to be provided.

18. The method according to claim 17, wherein said step of determining comprises the steps of:
determining the telephony resources available;
calculating the length of each call; and
determining the number of telephones required for the service, based on the length of each call and the size of the distribution list.

19. The method according to claim 19, wherein said step of determining comprises the step of:
the directing party allocating a level of priority to the communication.

20. The method according to claim 19, wherein said step of determining further comprising the steps of:
the system denying the service due to shortage of resources available at the time period requested; and
the directing party rescheduling the time period for the communication in accordance with the telephony resources available and level of priority.

21. The method according to claim 19, wherein said step of determining comprises the step of:
comparing the cost of the communication with the credit available to the client.

22. The method according to claim 21, wherein said step of determining further comprises the step of:
requesting additional credit to cover the cost of the communication or denying the service if not enough credit is available.

23. The method according to claim 8, wherein said step of analyzing the responses comprises the steps of:
analyzing the participants input;
preparing a report; and
transmitting the report in real time to the directing party.

24. The method according to claim 23, wherein said report may comprise any of a group of reporting formats including lists, graphs and charts

25. The method according to claim 8, wherein said step of initiating comprises the steps of:
allocating a time slot for a plurality of callers to dial a dedicated number;
preparing and recording a script; and
playing said script to said plurality of callers.

26. The method according to claim 25, wherein said step of initiating comprises the step of permitting the plurality of callers to transfer to a human resource for specific interactive discussions.
